(19) United States
(12) Patent Application Publication
(10) Pub. No.: US 2006/0260180 A1
(43) Pub. Date: Nov. 23, 2006

(54) Deep-water squid jig

(76) Inventor: Ben Hong, Torrance, CA (US)

Correspondence Address: LAW OFFICES OF CLEMENT CHENG, 17220 NEWHOPE STREET #127, FOUNTAIN VALLEY, CA, 92708, US

(21) Appl. No.: 11/130,607

(22) Filed: May 17, 2005

(51) Int. Cl. A01K 85/00; A01K 85/01

(52) U.S. Cl. 43/42.39; 43/17.6

(57) ABSTRACT

A deep-water squid jig is provided to have a one-piece solid spine on which a main body in the shape of a squid, a number of sub-bodies or orbs and a series of multi-prong hooks are threaded. The main body and orbs are made of a luminous glow-in-the-dark plastic material. A swivel is attached to a looped top of the spine for the fishing line hook up. A number of multi-prong hooks are provided to catch the squid as it attacks the lure hooking itself on the multiple hooks. Also, a cylindrical handle is installed on the top portion of the spine above the main body to manipulate the jig and a squid caught out of the water. To the lower end of the jig is attached a lead weight which may be held there by a couple of O-rings seated on grooves formed at the lower end of the spine. The weighted deep-water squid jig may have lead molded directly into the body of the lure. So, fishermen would not have to add weights to the lure that is conventional in the art of squid fishing.

### BACKGROUND OF THE INVENTION

A. Field of the Invention

The present invention relates to jig lures. More particularly, the invention relates to a deep-water squid jig for use with a fishing pole to catch more Squids with ease.

B. Description of the Prior Art

Market Squid and Giant Squid sometimes called Humboldt squid are found in oceans all around the world. Squids typically feed on fish, crustaceans, and other squids consuming up to 10% of their body weight per day. Squid is popular seafood enjoyed by many and to some considered delicacies. Squid can survive in waters as deep as several thousand feet deep.

Commercial fishermen catch squids using nets, seines, and squid lures. The only legal way in many states for a recreational fisherman in the U.S. to catch squid is by use of a squid jig or lure fished on a fishing pole. Squid jigs are designed to resemble shrimp, fish, or other squids. Although squids are sometimes caught in shallow/surface waters, most squids are brought up from hundreds and even thousands of feet deep water. Most commonly, fishermen tie weights to their fishing line to sink their squid lures into deep water where squids thrive.

### SUMMARY OF THE INVENTION

The weighted deep-water squid jig is designed according to the present invention to have lead molded into the body of the squid lure so fishermen would not have to add additional weights. Five or more multi-prong hooks are used to catch the squid as the squid attacks the lure hooking itself on the multiple hooks.

According to the present invention, the deep-water squid jig has a one-piece solid spine on which a main body in the shape of a squid and a series of multi-prong hooks are threaded. The main body and the orbs are made of a luminous glow-in-the-dark plastic material.

A swivel is attached to a looped top of the spine for the fishing line hook up. Five or other predetermined number of multi-prong hooks are provided to catch the squid as it attacks the lure hooking itself on the multiple hooks. Also, a cylindrical handle is installed on the top portion of the spine above the main body to manipulate the jig and a squid caught out of the water. To the lower end of the jig is attached a lead weight which may be held there by a couple of O-rings seated on grooves formed at the lower end of the spine.

The weighted deep-water squid jig of the present invention may have lead molded directly into the body of the lure. So, fishermen would not have to add weights to the lure which is conventional in the art of squid fishing.

### BRIEF DESCRIPTION OF THE DRAWINGS

FIG. 1 a partial breakout view of the deep-water squid jig according to the present invention.

FIG. 2 is a cross-sectional view of the squid jig hook drawn along line 2-2 of FIG. 1.

FIG. 3 is a cross-sectional view of the squid jig of FIG. 1 showing the connection between the spine and the lead weight.

Similar reference numbers denote corresponding features throughout the attached drawings.

### DETAILED DESCRIPTION OF THE PREFERRED EMBODIMENT

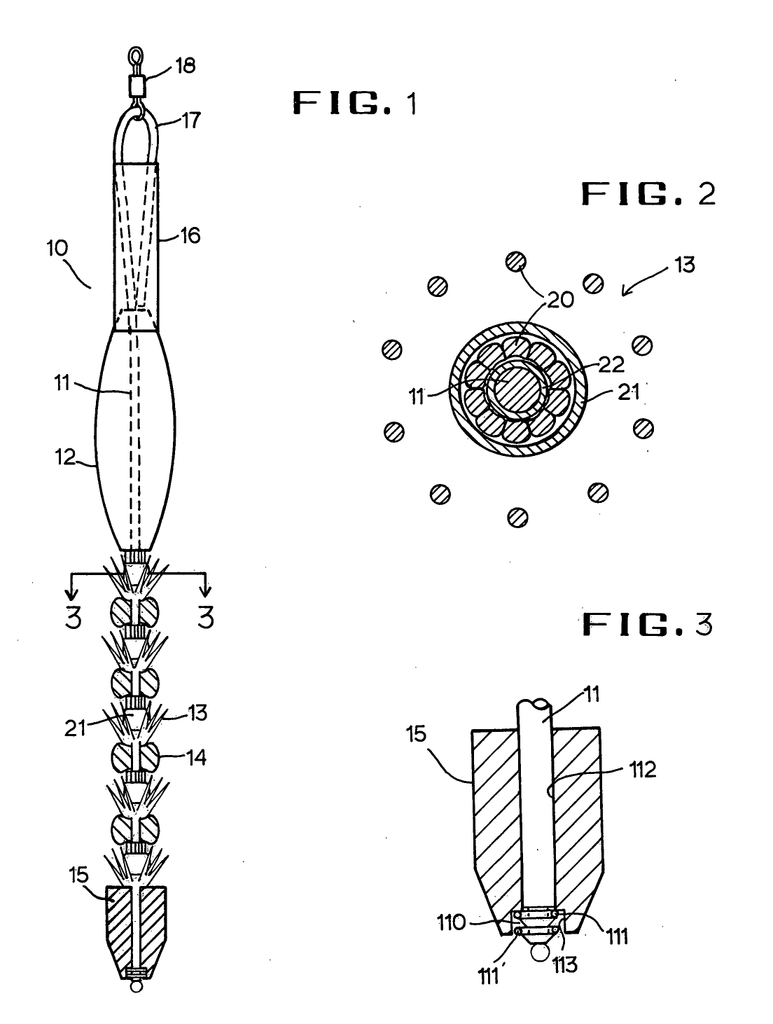

With reference to FIG. 1, a deep-water squid jig 10 has a solid piece of spine 11 on which there are threaded all of the component parts of the present invention including a main lure body 12 and a series of multi-prong hooks 13. Alternate to the hooks 13 there are provided a plurality of sub-bodies 14 in the shape of orbs.

Under the lowest hook 13 is threaded a lead weight 15 terminating the bottom of the jig 10. Adjacent to the main body 12 a cylindrical handle 16 is provided to extend over a top portion of the spine 11. Above the handle 16 the spine 11 is formed as a loop 17 to which a swivel 18 is attached to provide an eye for fastening a fishing line.

Catching up with squids in the deep ocean the spine 11 is a high strength steel rod according to one embodiment of the present invention.

In assembly of the jig 10, up along the spine 11 the handle 11 is pushed and the lure body 12 follows. The body 12 is made of a luminous glow-in-the-dark plastic material shaped to look well like a squid in the deep sea to lure hungry squids.

A multi-prong hook 13 is then installed on the spine 11 under the body 12. FIG. 2 shows the construction of the hook 13 in detail wherein multiple prongs 20 are disposed radially in equal distances and held firmed between an outer sleeve 21 and inner sleeve 22 to complete the hook 13 subassembly.

The orb 14 is then skewered and a predetermined number of hooks 13 and orbs 14 are added in an alternate fashion. This serial alternate pattern of hooks 13 with orbs 14 provides the most effective area longitudinally to catch the squid with the best chance for a single line fishing.

The equidistant orbs 14 complement the main body 12 to realistically attract the target Giant Squids with ready underwater visibility while the razor sharp hooks 13 are invisibly hidden among the body 12 and the orbs 14. The illustrated embodiment has four orbs 14 and five hooks 13 although other number sets are possible within the scope of the present invention.

FIG. 3 shows the spine 11 has a lower end 110 with grooves to receive a couple of O-rings 111 and 111′. The lead weight 15 has a center hole 112 through which the spine 11 extends and a stepped area 113 where the O-rings 111 and 111′ are seated to lock up all the component parts of the squid jig along the spine 11.

Alternatively, lead may be molded into the jig body to replace the lead weight 15.

Finished jig 10 measures twenty inches in length and weighs twenty four ounces although other sizes and weights are acceptable according to the present invention. Other sizes are also possible. In smaller embodiments, the orbs 21 can be omitted and the top swivel 18 can also be omitted. In the smaller sizes, the handle 16 can also be omitted.

An eyelet can be added to the bottom end of the lead weight 15 attaching to O Ring 111. The eyelet provides an attachment for fishing line or cord allowing grasping of the lower end of the device when detaching caught squid from the device. Furthermore, the lead weight 15 is preferably coated with glow in the dark phosphor luminescent paint.

It is to be understood that the present invention is not limited to the sole embodiment describe above, but encompasses any and all embodiments within the scope of the following claims.

1. A squid jig for deep water fishing of Market or Giant Squids comprising:
a spine member disposed longitudinally having a top end allowing attachment of a fishing line,
a lure body in the general shape of a squid having a longitudinal center hole through which said spine member extends,
a predetermined number of multi-prong hooks each having a number of radially outwardly extending prongs defining a longitudinal opening in the center to hold a section of said spine member therein, and
a lead weight encircling said spine member at its lower end.

2. The squid jig of claim 1, wherein said spine member is constructed of a one-piece solid steel rod.

3. The squid jig of claim 1, wherein said spine member is formed into a loop at its upper end and further comprises a cylindrical handle to be fitted over said loop to manipulate said jig and a squid caught out of the water.

4. The squid jig of claim 1, wherein said lure body and sub-bodies are made of a luminous glow-in-the-dark plastic material.

5. The squid jig of claim 1, wherein said multi-prong hooks are at least five subassemblies of said jig.

6. The squid jig of claim 1, wherein said hook has prongs of sixteen the proximal ends of which are sandwiched in an annular space between an inner and outer sleeves.

7. The squid jig of claim 1, wherein said lead weight glows in the dark.

8. The squid jig of claim 1, wherein said lead weight is an annular member threaded by said spine member and at least one O-ring is added to fasten said weight on said spine member.

9. The squid jig of claim 1, wherein said lead weight is molded directly onto said lower end of said spine member to complete said squid jig.

10. A squid jig for deep water fishing of Market or Giant Squids comprising:
a spine member disposed longitudinally having a top end allowing attachment of a fishing line,
a lure body in the general shape of a squid having a longitudinal center hole through which said spine member extends,
a predetermined number of multi-prong hooks each having a number of radially outwardly extending prongs defining a longitudinal opening in the center to hold a section of said spine member therein,
a predetermined number of sub-bodies which are smaller than said lure body and interposed longitudinally between said hooks, and
a lead weight encircling said spine member at its lower end.

12. The squid jig of claim 10, wherein said spine member is constructed of a one-piece solid steel rod.

13. The squid jig of claim 10, wherein said spine member is formed into a loop at its upper end and further comprises a cylindrical handle to be fitted over said loop to manipulate said jig and a squid caught out of the water.

14. The squid jig of claim 10, wherein said lure body and sub-bodies are made of a luminous glow-in-the-dark plastic material.

15. The squid jig of claim 10, wherein said multi-prong hooks are at least five subassemblies of said jig.

16. The squid jig of claim 10, wherein said hook has prongs of sixteen the proximal ends of which are sandwiched in an annular space between an inner and outer sleeves.

17. The squid jig of claim 10, wherein said sub-bodies are in the shape of orbs.

18. The squid jig of claim 10, wherein said lead weight is an annular member threaded by said spine member and a couple of O-rings are added to fasten said weight on said spine member.

19. The squid jig of claim 10, wherein said lead weight is molded directly onto said lower end of said spine member to complete said squid jig.
